(19) United States
(12) Patent Application Publication
(10) Pub. No.: US 2006/0022530 A1
(43) Pub. Date: Feb. 2, 2006

(54) Internal ventilation fan for brushless motor

(76) Inventor: Brian Havel, London (CA)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/195,043

(22) Filed: Aug. 2, 2005

Related U.S. Application Data
(60) Provisional application No. 60/598,126, filed on Aug. 2, 2004.

(51) Int. Cl. H02K 9/00

(52) U.S. Cl. 310/58

(57) ABSTRACT

A brushless motor includes stationary windings 16. A magnet assembly 24 has permanent magnets 24 associated with the windings 16 so that a magnetic field generated by the windings 16 causes rotation of the magnet assembly 14. The magnet assembly 24 defines a fan hub 26. Fan blades 28 are integral with the fan hub 26 and are generally adjacent to the windings 16, such that rotation of the magnet assembly 24 causes the fan blades 28 to generate airflow past the windings 16 to cool the windings.

This application claims the benefit of the earlier filing date of U.S. Provisional Application No. 60/598,126, filed on Aug. 2, 2004, which is incorporated by reference herein in its entirety.

### FIELD OF THE INVENTION

The invention relates to cooling heat-producing components of a motor and, more particularly, to an axial fan that is integrated into a brushless motor.

### BACKGROUND OF THE INVENTION

Heat generated in a motor must be removed for efficient and reliable operation of the motor. Self-cooling can be achieved by moving air through the motor. This is typically achieved by providing ventilation holes in the motor case to permit ambient air to pass through the motor. Cooling can be optimized if the airflow is targeted over the heat-producing components, such as the field windings of the motor. With higher flow rates, higher heat transfer is possible.

Thus, there is a need to self-cool a motor by providing an internal fan that moves air past windings of the motor.

### SUMMARY OF THE INVENTION

An object of the invention is to fulfill the need referred to above. In accordance with the principles of the present invention, this objective is obtained by providing a brushless motor including stationary windings and a magnet assembly having permanent magnets associated with the windings so that a magnetic field generated by the windings causes rotation of the magnet assembly. The magnet assembly defines a fan hub. Fan blades are integral with the fan hub and are disposed generally adjacent to the windings, such that rotation of the magnet assembly causes the fan blades to generate airflow past the windings to cool the windings.

In accordance with another aspect of the invention, a method of self-cooling a permanent magnet motor is provided. The motor has stationary windings and a magnet assembly having permanent magnets associated with the windings so that a magnetic field generated by the windings causes rotation of the magnet assembly. The method provides a plurality of fan blades integral with the magnet assembly and associated with the windings. Current is supplied to the windings to cause rotation of the magnet assembly and thus the fan blades to cause airflow past the windings.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a front view of a brushless motor having an internal fan provided in accordance with the principles of the present invention.

FIG. 2 is a partial end view of the motor of FIG. 1, showing the blades pulling air past the windings.

FIG. 3 is a partial end view of the motor of FIG. 1 showing the blades pushing air past the windings.

### DETAILED DESCRIPTION OF THE EXEMPLARY EMBODIMENT

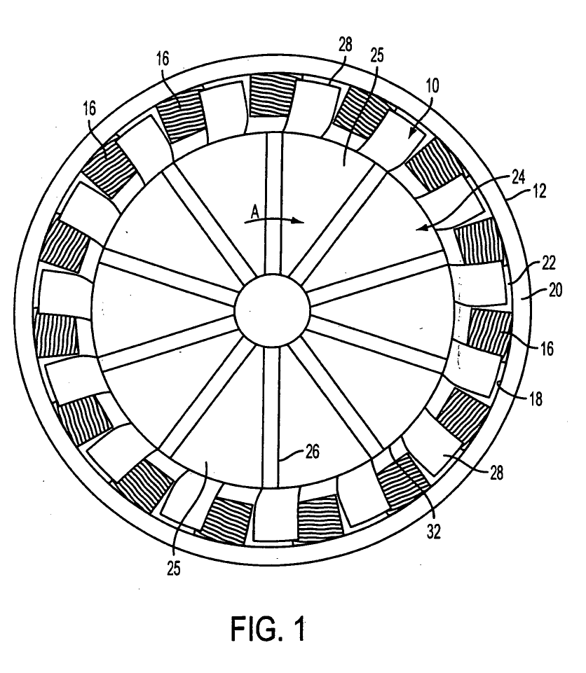

As shown in FIG. 1, an axial fan, generally indicated at 10, is integrated into a brushless motor 12. The motor 12 includes stationary windings 16 that are fixed with respect to a generally annular inner peripheral surface 18 of a stator housing 20. The peripheral surface 18 defines an interior space 22.

The motor includes a magnet assembly, generally indicated at 24, having permanent magnets 25 associated with the windings 16 so that a magnetic field generated by the windings 16, when current is applied thereto, causes rotation of the magnet assembly 24. It can be appreciated that the number of magnets 25 provided is determined by the number of poles of the motor. Also, the magnets 25 should be mounted to ensure balanced rotation of the magnet assembly 24.

The magnet assembly 24 defines a fan hub 26. Fan blades 28 are integral with the fan hub 26 and disposed generally adjacent to the windings 16, such that rotation of the magnet assembly 24 causes the fan blades 28 to generate airflow past the windings 16 to cool the windings. The fan blades 28 are disposed within the interior space 22 and extend towards the inner peripheral surface. Hence, the fan blades 28 are provided entirely inside of the motor 12 with the fan hub and fan blades 28 defining an internal fan of the motor 12.

The fan hub 26 is generally annular having a central portion 30 and a periphery 32. The fan blades 28 are mounted to the periphery 32 of the fan hub 26 and the permanent magnets 25 are mounted with respect to the central portion 30.

The magnet assembly 24 (fan hub 26) rotates in the direction of arrow A (FIG. 1) in response to a magnetic field generated by stationary windings 16, and therefore causes the fan blades 28 to move, generating airflow over and past the field windings 16 thereby cooling the windings 16. In the illustrated embodiment, the fan blades 28 are spaced evenly, but the fan blades 28 can be unevenly spaced.

The windings 16 generate heat; therefore an optimized position to locate the fan blades 28 that cool the windings 16 is directly over the windings 16. The fan forces air to move over the field windings thereby removing heat from the windings 16.

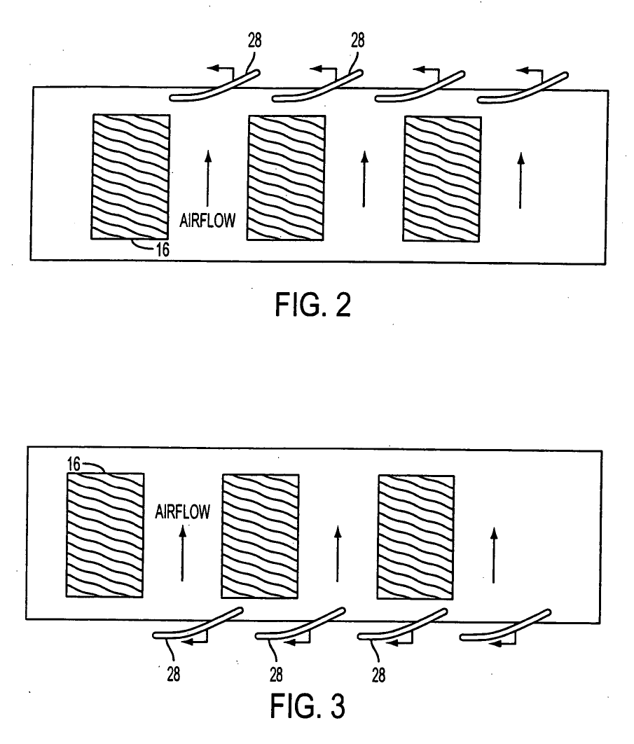

The windings 16 are disposed in spaced relation about the inner peripheral surface 18 of a stator housing 20 and the fan blades 28 are constructed and arranged to move air over and between adjacent windings 16. As shown in FIG. 2, the fan blades 28 are constructed and arranged to pull air past the windings 16. Alternatively, as shown in FIG. 3, the fan blades 28 can be constructed and arranged to push air past the windings 16.

The highest airflow can be generated if the radius of the internal fan is minimized. The embodiment disclosed targets the hot spots of the motor 12 and at the same time is efficient within the available radius of the motor 12.

The brushless motor 12 of the embodiment is preferably used in automotive-applications to provide power for engine cooling modules, power steering, electric drives for condensers, power steering, water pumps, etc. In that regard, a shaft (not shown) can be coupled with the magnet assembly for rotation therewith.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A brushless motor comprising:
stationary windings,
a magnet assembly having permanent magnets associated with the windings so that a magnetic field generated by the windings causes rotation of the magnet assembly, the magnet assembly defining a fan hub, and
a plurality of fan blades integral with the fan hub and disposed generally adjacent to the windings such that rotation of the magnet assembly causes the fan blades to generate airflow past the windings to cool the windings,
wherein the stationary windings are fixed with respect to a generally annular inner peripheral surface of a stator housing the peripheral surface defining an interior space with the windings being within the interior space, the fan blades being within the interior space and extending towards the inner peripheral surface.

2. The brushless motor of claim 1, wherein the fan hub is generally annular having a central portion and a periphery, the fan blades being mounted to the periphery of the fan hub.

3. (canceled)

4. The brushless motor of claim 2, wherein the permanent magnets are mounted with respect to the central portion of the fan hub.

5. The brushless motor of claim 1, wherein the windings are disposed in spaced relation about the inner peripheral surface and the fan blades are constructed and arranged to move air over and between adjacent windings.

6. The brushless motor of claim 5, wherein the fan blades are constructed and arranged to push air past the windings.

7. The brushless motor of claim 5, wherein the fan blades are constructed and arranged to pull air past the windings.

8. The brushless motor of claim 1, wherein the fan blades are entirely internal of the motor.

9. A brushless motor comprising:
means for generating a magnetic field due to the application of electric current thereto,
a magnet assembly having permanent magnets associated with the means for generating so that the magnetic field generated causes rotation of the magnet assembly, and
means, integral with the magnet assembly, for creating airflow past the means for generating to cool the means for generating upon rotation of the magnet assembly,
wherein the means for generating are stationary windings fixed with respect to a generally annular inner peripheral surface of a stator housing, the peripheral surface defining an interior space with the windings being within the interior space, and wherein the means for creating being fan blades disposed within the interior space and extending towards the inner peripheral surface.

10. The brushless motor of claim 9, wherein the magnet assembly defines a generally annular hub having a central portion and a periphery, and wherein the means for creating being mounted to the periphery of the hub.

11. (canceled)

12. The brushless motor of claim 10, wherein the permanent magnets are mounted with respect to the central portion of the hub.

13. The brushless motor of claim 9, wherein the windings are disposed in spaced relation about the inner peripheral surface and the fan blades are constructed and arranged to move air over and between adjacent windings.

14. The brushless motor of claim 13, wherein the fan blades are constructed and arranged to push air past the windings.

15. The brushless motor of claim 13, wherein the fan blades are constructed and arranged to pull air past the windings.

16. The brushless motor of claim 9, wherein the fan blades are entirely internal of the motor.

17. A method of self-cooling a permanent magnet motor, the motor having stationary windings fixed with respect to a generally annular inner peripheral surface of a stator housing the peripheral surface defining an interior space with the windings being within the interior space, the motor having a magnet assembly having permanent magnets associated with the windings so that a magnetic field generated by the windings causes rotation of the magnet assembly, the method including:
providing a plurality of fan blades integral with the magnet assembly and associated with the windings, the fan blades being within the interior space and extending towards the inner peripheral surface, and
supplying current to the windings to cause rotation of the magnet assembly and thus the fan blades to cause airflow past the windings.

18. The method of claim 17, wherein the providing step includes providing the magnet assembly to define a generally annular hub having a central portion and a periphery, with the fan blades being mounted to the periphery of the hub, internal of the motor.
